(19) United States
(12) Patent Application Publication
(10) Pub. No.: US 2006/0246294 A1
(43) Pub. Date: Nov. 2, 2006

(54) Circuit materials, circuits, and methods of manufacture thereof

(76) Inventor: Vincent R. Landi, Phoenix, AZ (US)

Correspondence Address: CANTOR COLBURN, LLP, 55 GRIFFIN ROAD SOUTH, BLOOMFIELD, CT, 06002, US

(21) Appl. No.: 11/413,061

(22) Filed: Apr. 27, 2006

Related U.S. Application Data
(60) Provisional application No. 60/675,211, filed on Apr. 27, 2005.

(51) Int. Cl. C23C 26/00; B32B 9/04; B32B 15/04

(52) U.S. Cl. 428/411.1; 428/457; 427/96.1

(57) ABSTRACT

A circuit material, comprises a conductive layer; and a dielectric substrate disposed on the conductive layer, the dielectric substrate comprising, based on the total dielectric substrate composition, about 10 to about 60 vol. % of a fibrous web; and about 40 to about 90 vol. % of a cured resin system, wherein the resin system comprises up to 100 vol. % of a syndiotactic polybutadiene elastomer, and 0 to 40 vol. % of a particulate filler, based on the combined weight of the resin system and the particulate filler. Such circuit materials have improved tack and good mechanical and electrical properties.

### CROSS-REFERENCE TO RELATED APPLICATION

This application claims priority to U.S. Provisional Application Serial No. 60/675,211 filed Apr. 27, 2005, which is incorporated by reference herein in its entirety.

### BACKGROUND OF THE INVENTION

This invention relates to polybutadiene and/or polyisoprene compositions useful in the formation of circuit materials, circuits, and multi-layer circuits.

As used herein, a circuit material is an article used in the manufacture of circuits and multi-layer circuits, and includes circuit laminates, bond plies, resin coated conductive layers, and cover films. A circuit laminate refers to a circuit material having one or two conductive layers fixedly attached to a dielectric substrate, which is formed from a dielectric material. Patterning a conductive layer of a laminate, e.g., by etching, provides a circuit. Multi-layer circuits comprise a plurality of conductive layers, at least one of which contains a conductive wiring pattern. Typically, multi-layer circuits are formed by laminating one or more circuits together using bond plies, and, in some cases, resin coated conductive layers, in proper alignment using heat and/or pressure. The bond plies are used to provide adhesion between circuits and/or between a circuit and a conductive layer, or between two conductive layers. In place of a conductive layer bonded to a circuit with a bond ply, the multi-layer circuit may include a resin coated conductive layer bonded directly to the outer layer of a circuit. In such multi-layer structures, after lamination, known hole forming and plating technologies may be used to produce useful electrical pathways between conductive layers.

The dielectric materials used to form circuit materials may comprise a thermosetting or thermoplastic polymer. Dielectric substrates, i.e., the dielectric material in a circuit laminate, are typically divided into two classes, flexible and rigid. Flexible dielectric substrates generally tend to be thinner and more bendable than the so-called rigid dielectric substrates, which typically comprise a fibrous web or other form of reinforcement, such as short or long fibers or fillers. Thus, dielectric substrates used in circuit boards are most commonly composites, comprising a polymeric matrix and an inorganic particulate and/or fibrous filler.

Polybutadiene resins, polyisoprene resins, and combinations thereof are particularly useful thermosetting compositions for dielectric substrates, and are described in commonly assigned U.S. Pat. No. 5,233,568 to Landi et al., U.S. Pat. No. 5,571,609 to St. Lawrence et al., U.S. Pat. No. 6,048,807 to St. Lawrence, and U.S. Pat. No. 6,586,533 to Landi, all of which are herein incorporated by reference in their entirety. U.S. Pat. No. 5,233,568 discloses a moldable thermosetting composition that is first formed into a shape, and then cured at a temperature of greater than about 250° C. U.S. Pat. No. 5,571,609 discloses a thermosetting resin system comprising a polybutadiene and/or polyisoprene resin, an unsaturated butadiene- or isoprene-containing polymer in an amount of 25 to 50 volume percent (vol. %); a woven glass fabric in an amount of 10 to 40 vol. %; and a particulate filler in an amount of 5 to 60 vol. %. U.S. Pat. No. 6,586,533 discloses a broad range of butadiene- or isoprene polymer or copolymers that can undergo a thermal cure to achieve useful properties as a resin for circuit board substrates. The thermal cure takes place at a high temperature (e.g., greater than about 250° C.), without loss of copper bonding strength. It is taught in U.S. Pat. No. 6,586,533 that high molecular weight butadiene or isoprene polymers may be useful in cases where a high amount of filler are employed, so that liquid resin does not separate and drain away from the filler. Use of a high molecular weight syndiotactic polybutadiene is also disclosed in U.S. Pat. No. 6,586,533, but the only examples using syndiotactic polybutadiene use it in combination with high amounts of silica filler i.e., about 80 wt. % silica filler, based on the combined weight of resin and filler (Table 2).

It is known to add particulate fillers to circuit substrate compositions for a variety of reasons. U.S. Pat. No. 5,264,065 to Kohm describes a base material for printed wiring boards where inert filler is used to control the Z-axis coefficient of thermal expansion in fiberglass-reinforced thermoset resins. This patent discloses use of 45 to 65 weight percent (wt. %) fiberglass reinforcement and 30 to 100 parts inert filler per 100 parts of the polymer. U.S. Pat. No. 4,997,702 to Grant et al. discloses a circuit laminate having an epoxy resin system that also includes inorganic fillers or fibers in an amount of about 20 to 70 wt. % of the total composite. The fibers include both glass and polymeric fibers and the fillers include clay or mineral (e.g., silica) particulate fillers. U.S. Pat. No. 4,241,132 to Pratt et al. discloses an insulating board comprising a polymeric matrix such as polybutadiene and a polymer filler, e.g., fibrous polypropylene. In all cases, the dielectric constant or dissipation factor of the resin matrix is matched to the fibrous reinforcement in order to obtain an isotropic composite. U.S. Pat. No. 6,586,533 to Landi discloses that at least 40% by volume of particulate filler (silica), based on the total volume of resin, filler, and woven fiberglass reinforcement, is required in order to make the prepreg adequately tack-free to be handled.

While the above composites are well suited for their intended purposes, they require a high loading of filler to render them low in tack. These high loadings of filler have undesirable consequences in certain important applications. One of these is related to the inherent abrasiveness of the ceramic filler, which causes unwanted wear of drill bits routinely used in the fabrication of circuit boards. Drill bits are known to have significantly reduced lifetimes because of ceramic filler, such as silica, in circuit board compositions. This great loss in drill lifetimes is a serious economic disadvantage in the use of ceramic filled resin systems. Another frequently unwanted consequence of the filler is associated with its higher dielectric constant as compared to the resin. At an equal coating thickness on glass fabric, dielectric constant is increased in proportion to the amount of filler contained in the polymer/filler coating layer. Consequently, there is a perceived need in the art for printed circuit board materials with the advantages of those materials described in U.S. Pat. No. 5,571,609, and U.S. Pat. No. 6,048,807, but without the particulate filler.

In the absence of fillers, other measures have been used to reduce tack. European Patent No. 202 488 A2 discloses a polybutadiene-based laminate wherein a high molecular weight, bromine-containing prepolymer is used to reduce tack and flammability of a 1,2-polybutadiene resin. Similarly, in Japanese Patent No. 04,258,658, a high molecular weight halogen-containing bismaleimide is added to a tacky polybutadiene resin to control tack. There is no mention of the use of fillers, and the resulting laminate has a relatively high dissipation factor. An article titled “A New Flame Retardant 1,2-Polybutadiene Laminate,” by N. Sawatri et al., IEEE Transactions on Electrical Insulation, Vol. EI-18, No. 2, April 1983, discloses use of a high percentage of very high molecular polybutadiene and a low molecular weight, modified polybutadiene as a minor component, but there is no mention of the use of filler of any type. Another article, entitled “1,2 Polybutadiene-High Performance Resins for the Electrical Industry,” by R. E. Drake, ANTEC '84, pp. 730-733 (1984), generally discloses conventional polybutadiene resins for use in laminates and specifically discloses the use of reactive monomers that react with the polybutadiene. U.K. Patent Application 2 172 892A generally discloses laminates composed of styrene-containing and thermoplastic copolymers with unsaturated double bonds and polybutadiene.

While certain of the above-described materials are well-suited for their intended purposes, there nonetheless remains a continuing need in the art for dielectric materials with improved handling characteristics, particularly improved tack prior to cure. It has been difficult to achieve this goal because formulations that have low tack during processing can also have less desirable properties after cure. Accordingly, there remains a need in the art for dielectric compositions for use in circuit materials with improved handling characteristics, particularly tack, without significant degradation in other properties.

### BRIEF SUMMARY OF THE INVENTION

The above-discussed and other drawbacks and deficiencies of the prior art are overcome or alleviated by a circuit material comprising a conductive layer; and a dielectric substrate disposed on the conductive layer, the dielectric substrate comprising, based on the total volume of the dielectric substrate composition, about 10 to about 60 vol. % of a fibrous web; and about 40 to about 90 vol. % of a cured composition, formed from a resin system comprising a syndiotactic polybutadiene elastomer, in an amount of up to 100 vol. % of the volume of resin system; and 0 to 40 vol. % of a particulate filler, based on the combined volume of the particulate filler and the resin system. Optionally, the resin system can further comprise up to about 90 wt. % of a polybutadiene and/or polyisoprene resin, up to about 20 wt. % of a low molecular weight ethylene propylene (EPM) or ethylene propylene diene terpolymer (EPDM) elastomer, up to about 60 wt. % of a thermoplastic polymer capable of participating in cross-linking with the polybutadiene resin, and an effective quantity of a free radical curing agent, each based on the total volume or weight of the resin system.

In another embodiment, the resin system comprises about 5 to about 90 wt. % of the syndiotactic polybutadiene elastomer, and about 10 to about 95 wt. % of a liquid polybutadiene and/or polyisoprene resin, each based on the total weight of the resin system.

In still another embodiment, the dielectric substrate comprises 0 to 4 vol. % particulate filler, based on the combined volume of the resin system and particulate filler.

In yet another embodiment, the dielectric substrate is formed from a fibrous web; a particulate filler; and a resin system that comprises about 5 to about 90 wt. % of a syndiotactic polybutadiene elastomer and about 10 to about 95 wt. % of a liquid polybutadiene and/or polyisoprene resin, each based on the total weight of the resin system; wherein the particulate filler is present in an amount of 0 to about 4 vol. %, based on the combined volume of the resin system and particulate filler.

The above substrates possess improved handling characteristics during processing, without substantial degradation of other properties, for example without raising dielectric constant and dissipation factor and/or lowering mechanical properties. In one embodiment, the composition contains no particulate filler.

A method for the manufacture of the above-described circuit material is also provided, comprising disposing the above-described composition onto the conductive layer.

The above discussed and other features and advantages of the present invention will be appreciated and understood by those skilled in the art from the following detailed description, drawings, and appended claims.

### BRIEF DESCRIPTION OF DRAWINGS

Referring now to the exemplary drawings wherein like elements are numbered alike in the several FIGURES:

FIG. 1 is a schematic representation of an exemplary circuit material comprising the dielectric composite and a conductive layer; and

FIG. 2 is a schematic representation of a double clad circuit comprising the dielectric composite.

### DETAILED DESCRIPTION

It has unexpectedly been found by the inventor hereof that a circuit substrate material having excellent properties can be produced using a resin system by substituting a syndiotactic 1,2-polybutadiene elastomer for all or a portion of a liquid 1,2-polybutadiene resin or 1,2-polyisoprene resin. Such compositions have remarkably reduced tack, together with excellent electrical and mechanical properties in the cured state. The reduced tack of the resin system, allows a substantial reduction in the amount of filler necessary for the low tack, with a concomitant lowering of dielectric constant, and improved drillability. In one embodiment, substrates having 0 to less than 5 vol. % filler may be obtained with good results.

The resin system used in the circuit substrate material generally comprises a thermosetting syndiotactic 1,2-polybutadiene elastomer; optionally, a thermosetting polybutadiene or polyisoprene resin, preferably a liquid thermosetting polybutadiene or polyisoprene resin; optionally, a thermoplastic polymer capable of participating in crosslinking with the syndiotactic 1,2-polybutadiene and polybutadiene or polyisoprene resin during cure, for example an unsaturated butadiene- or isoprene containing polymer; and optionally, an ethylene propylene (EPM) or ethylene propylene diene terpolymer (EPDM). Other polymer or monomer components can also be present.

The resin system first comprises a syndiotactic 1,2-polybutadiene elastomer. The elastomer should contain crystallinity at room temperature, but not so much that is soluble with difficulty in practical processing solvents such as xylene. It can be of low or high molecular weight, e.g. a weight average molecular weight of about 5000 to about 200,000, with a practical choice depending on commercial availability. The crystallinity level is preferably chosen so as to provide ready solubility in a solvent during processing, particularly during saturation of a fibrous web. In one embodiment, the syndiotactic 1,2-polybutadiene has a crystallinity of about 15 to about 30%. The syndiotactic 1,2-polybutadiene can also have greater than 70%, specifically greater than 80%, and more specifically greater than 90% 1,2 addition. A suitable high molecular weight syndiotactic 1,2-polybutadiene is available from Japan Synthetic Elastomer under the trade name JSR 810.

The syndiotactic polybutadiene is present in the resin system in an amount of about 5 to about 100 wt. %, based on the total weight of the resin system, specifically about 10 to about 90 wt. %, more specifically about 10 to about 60 wt. %, even more specifically about 30 to about 45 wt. %.

A non-syndiotactic thermosetting polybutadiene and/or polyisoprene resin can also be present in the resin system. As used herein, the term “thermosetting polybutadiene and/or polyisoprene resin” includes homopolymers and copolymers comprising units derived from butadiene, isoprene, or mixtures thereof. Units derived from other copolymerizable monomers can also be present in the resin, for example randomly copolymerized or in the form of grafts. Exemplary copolymerizable monomers include but are not limited to vinylaromatic monomers, for example substituted and unsubstituted monovinylaromatic monomers such as styrene, 3-methylstyrene, 3,5-diethylstyrene, 4-n-propylstyrene, alpha-methylstyrene, alpha-methyl vinyltoluene, para-hydroxystyrene, para-methoxystyrene, alpha-chlorostyrene, alpha-bromostyrene, dichlorostyrene, dibromostyrene, tetra-chlorostyrene, and the like; and substituted and unsubstituted divinylaromatic monomers such as divinylbenzene, divinyltoluene, and the like. Combinations comprising at least one of the foregoing copolymerizable monomers can also be used. Exemplary thermosetting polybutadiene and/or polyisoprene resin include but are not limited to butadiene homopolymers, isoprene homopolymers, butadiene-vinylaromatic copolymers such as butadiene-styrene, isoprene-vinylaromatic copolymers such as isoprene-styrene copolymers, and the like.

The thermosetting polybutadiene and/or polyisoprene resins can also be modified after polymerization, for example, the resins can be hydroxyl-terminated, methacrylate-terminated, carboxylate-terminated resins. Post-reacted resins can be used, such as such as epoxy-, maleic anhydride-, or urethane-modified butadiene or isoprene resins. The resins can also be crosslinked, for example by divinylaromatic compounds such as divinyl benzene, e.g., a polybutadiene-styrene crosslinked with divinyl benzene. Suitable resins are broadly classified as “polybutadienes” by their manufacturers, for example Nippon Soda and Sartomer Inc. Mixtures of resins can also be used, for example, a mixture of a polybutadiene homopolymer and a poly(butadiene-isoprene) copolymer, etc.

The thermosetting polybutadiene or polyisoprene resin can be liquid or solid at room temperature, with liquid resins preferred, in order to maintain the viscosity of the composition at a manageable level during processing. Suitable liquid resins can have a number average molecular weight greater than about 5000, but generally have a number average molecular weight of less than about 5000 (most preferably about 1,000 to about 3,000). Polybutadiene or polyisoprene resins having at least 90 wt. % 1,2 addition are preferred because they exhibit the greatest crosslink density upon cure, due to the large number of pendent vinyl groups available for crosslinking.

The polybutadiene and/or polyisoprene resin is present in the resin system in an amount of up to about 95 wt. % with respect to the total weight of the resin system, specifically up to about 60 wt. %, more specifically about 10 to about 55 wt. %, even more specifically about 15 to about 45 wt. %.

Other polymers that can co-cure with the thermosetting polybutadiene or polyisoprene resins can be added for specific property or processing modifications. For example, in order to improve the stability of the dielectric strength and mechanical properties of the electrical substrate material over time, a lower molecular weight ethylene propylene elastomer can be used in the resin systems. An ethylene propylene elastomer as used herein is a copolymer, terpolymer, or other polymer comprising primarily ethylene and propylene. Ethylene propylene elastomers may be further classified as EPM copolymers (i.e., copolymers of ethylene and propylene monomers), or EPDM terpolymers (i.e., terpolymers of ethylene, propylene, and diene monomers). Ethylene propylene diene terpolymer rubbers, in particular, have saturated main chains, with unsaturation available off the main chain for facile cross-linking. Liquid ethylene propylene diene terpolymer rubbers in which the diene is dicyclopentadiene are preferred.

Useful molecular weights of the ethylene propylene rubbers are less than 10,000 viscosity average molecular weight. Suitable ethylene propylene rubbers include an ethylene propylene rubber having a viscosity average molecular weight (MV) of about 7200, which is available from Uniroyal under the trade name Trilene CP80; a liquid ethylene propylene dicyclopentadiene terpolymer rubbers having a molecular weight of about 7,000, which is available from Uniroyal under the trade name of Trilene 65; and a liquid ethylene propylene ethylidene norbornene terpolymer, having a molecular weight of about 7500, available from Uniroyal under the name Trilene 67.

The ethylene propylene rubber is preferably present in an amount effective to maintain the stability of the properties of the substrate material over time, in particular the dielectric strength and mechanical properties. Typically, such amounts are up to about 20 wt. % with respect to the total weight of the resin system, more specifically about 4 to about 20 wt. %, even more specifically about 6 to about 12 wt. %.

Another type of co-curable polymer is an unsaturated polybutadiene- or polyisoprene-containing elastomer. This component can be a random or block copolymer of primarily 1,3-addition butadiene or isoprene with an ethylenically unsaturated monomer, for example a vinylaromatic compound such as styrene or alpha-methyl styrene, an acrylate or methacrylate such a methyl methacrylate, or acrylonitrile. The elastomer is preferably a solid, thermoplastic elastomer comprising a linear or graft-type block copolymer having a polybutadiene or polyisoprene block, and a thermoplastic block that preferably is derived from a monovinylaromatic monomer such as styrene or alpha-methyl styrene. Suitable block copolymers of this type include styrene-butadiene-styrene triblock copolymers, for example those available from Dexco Polymers, Houston, Tex. under the trade name Vector 8508M, from Enichem Elastomers America, Houston, Tex. under the trade name Sol-T-6302, and those from Fina Oil and Chemical Company, Dallas, Tex. under the trade name Finaprene 401; styrene-butadiene diblock copolymers; and mixed triblock and diblock copolymers containing styrene and butadiene, for example those available from Shell Chemical Corporation under the trade name Kraton D1118X. Kraton D1118X is a mixed diblock/triblock styrene and butadiene containing copolymer, containing 30 vol. % styrene.

The optional polybutadiene- or polyisoprene-containing elastomer can further comprise a second block copolymer similar to that described above, except that the polybutadiene or polyisoprene block is hydrogenated, thereby forming a polyethylene block (in the case of polybutadiene) or an ethylene-propylene copolymer block (in the case of polyisoprene). When used in conjunction with the above-described copolymer, at materials with greater toughness can be produced. An exemplary second block copolymer of this type is Kraton GX1855 (commercially available from Kraton Polymers.), which is described by the manufacturer as a mixture of a styrene-high 1,2-butadiene-styrene block copolymer and a styrene-(ethylene-propylene)-styrene block copolymer.

Typically, the unsaturated polybutadiene- or polyisoprene-containing elastomer component is present in the resin system in an amount of about 10 to about 60 wt. % with respect to the total weight of the resin system, more specifically about 20 to about 50 wt. %, even more specifically about 25 to about 40 wt. %.

Still other co-curable polymers that can be added for specific property or processing modifications include, but are not limited to, homopolymers or copolymers of ethylene such as polyethylene and ethylene oxide copolymers; natural rubber; norbornene polymers such as polydicyclopentadiene; hydrogenated styrene-isoprene-styrene copolymers and butadiene-acrylonitrile copolymers; unsaturated polyesters; and the like. Levels of these copolymers are generally less than 50 vol. % of the total resin system.

Free radical-curable monomers can also be added for specific property or processing modifications, for example to increase the crosslink density of the resin system after cure. Exemplary monomers that can be suitable crosslinking agents include, for example, di, tri-, or higher ethylenically unsaturated monomers such as divinyl benzene, triallyl cyanurate, diallyl phthalate, and multifunctional acrylate monomers (e.g., Sartomer resins available from Arco Specialty Chemicals Co.), or combinations thereof, all of which are commercially available. The crosslinking agent, when used, is present in resin system in an amount of up to about 20 vol. %, based on the total weight of the resin.

The resin systems can include other additives as known in the art, for example, antioxidants, flame retardants, and the like. Suitable flame retardants include, for example, bromine containing flame retardants such as ethylene bistetrabromophthalimide in an amount of about 20 phr (parts per hundred parts of resin system by weight) to about 60 phr.

A curing initiator can also be used, for example when a flame retardant is present, since a lower cure temperature helps to prevent decomposition of many flame retardants. Even when a high cure temperature, e.g., in excess of 250° C. is used (which is sufficient to cure butadiene or isoprene resins in the absence of a curing agent), a curing initiator may nonetheless be present. Suitable curing initiators are free radical cure initiators such as organic peroxides, e.g. dicumyl peroxide, t-butylperoxyperbenzoate, di(2-t-butylperoxyisopropyl)benzene, and t-butyl peroxyhexyne-3. Non-peroxide free radical cure initiators such as 2,3-dimethyl-2,3-diphenyl-butane can also be used. Curing agents can be provided in an amount of about 1 to about 10, more specifically about 1.5 to about 6 phr.

There are a number of different combinations of the foregoing resin systems that are of particular utility for the manufacture of dielectric substrates, and in particular, that will produce tack-free prepregs, even when low amounts of particulate filler are used.

For example, it has been found that use of a liquid thermosetting polybutadiene and/or polyisoprene is preferred in some instances because the liquid resin greatly increases the processability of the composition. Such resin systems comprise, based on the total weight of the resin system, about 5 to about 90 wt. %, specifically about 10 to about 60 wt. %, even more specifically about 30 to about 45 wt. % of a syndiotactic polybutadiene elastomer; about 10 to about 95 wt. %, specifically about 15 to about 55 wt. %, even more specifically about 20 to about 45 wt. % of a liquid polybutadiene or polyisoprene resin; optionally up to about 20 wt. % of a low molecular weight ethylene propylene (EPM) or ethylene propylene diene terpolymer (EPDM) elastomer; optionally up to about 50 wt. % of a thermoplastic polymer capable of participating in cross-linking with the polybutadiene resin; and optionally, an effective amount of a free radical curing agent. In another embodiment, the resin system consists essentially of the foregoing resin components. In still another embodiment, the resin system consists of the foregoing resin components.

In yet another embodiment, the resin system consists essentially of, based on the total weight of the resin system, about 5 to about 100 wt. %, specifically about 10 to about 60 wt. %, even more specifically about 30 to about 45 wt. %, of a syndiotactic polybutadiene elastomer; optionally, up to about 60 wt. %, specifically about 10 to about 55 wt. %, even more specifically about 15 to about 45 wt. % of a polybutadiene and/or polyisoprene resin; optionally up to about 20 wt. % of a low molecular weight ethylene propylene (EPM) or ethylene propylene diene terpolymer (EPDM) elastomer; optionally up to about 50 wt. % of a thermoplastic polymer capable of participating in cross-linking with the polybutadiene resin; and optionally, an effective amount of a free radical curing agent. In still another embodiment, the resin system consists of the foregoing resin components.

Any one of the resin systems described above allows the use of lower amounts of filler than heretofore thought possible. For example, U.S. Pat. No. 6,586,533 teaches that 40% by volume of silica (based on the total volume of the laminate) is required in order to make a prepreg adequately tack-free to be handled. In contrast, the inventor hereof has found that tack-free prepregs can be obtained when using less than 40 vol. % particulate filler, based on the combined volume of the resin system and particulate filler. This result is unexpected, and provides manufacturing advantages, especially during drilling of the laminates and circuits.

When present, the particulate filler material (and quantity, up to 40 vol. %) is selected so as to provide the dielectric substrate with a coefficient of thermal expansion that is more nearly matched to the coefficient of thermal expansion of the conductive metal layer. Examples of suitable fillers include titanium dioxide (rutile and anatase), barium titanate, strontium titanate, silica (particles and hollow spheres) including fused amorphous silica, corundum, wollastonite, aramide fibers (e.g., Kevlar), fiberglass, Ba₂Ti₉O₂₀, glass spheres, quartz, boron nitride, aluminum nitride, silicon carbide, beryllia, alumina, magnesia, and mixtures comprising at least one of the foregoing particulate fillers. Particularly preferred fillers are rutile titanium dioxide and amorphous silica because these fillers have a high and low dielectric constant, respectively, thereby permitting a broad range of dielectric constants combined with a low dissipation factor achievable in the final cured product by adjusting the respective amounts of the two fillers in the composition. To improve adhesion between the fillers and resin, coupling agents, e.g., silanes, titanates, and the like, can be used.

The volume percent of the filler (based upon the combined volume of the resin system and the particulate filler) can be up to 40 vol. %, with up to 30 vol. % preferred, and up to 20 vol. % especially preferred.

Even more unexpectedly, it has been found by the inventor hereof that use of syndiotactic polybutadiene can produce low tack compositions even in the absence of large amounts of particulate filler. Thus, in a particularly preferred embodiment, very little or no particulate filler is used, for example 0 to about 4 vol. %, more specifically 0 to about 2 vol. %, based on the combined volume of the resin system and the particulate filler. High surface area fillers are particularly useful in this embodiment, for example silica fillers having a surface area of greater than about 20 m²/g.

The resin system (and any particulate filler) can be used to coat and fill a fibrous web reinforcement. As used herein, a fibrous web includes any woven or non-woven assemblage of fibers capable of withstanding the processing conditions used in the manufacture of circuit board materials and the circuits formed therefrom. The fibrous web comprises thermally stable webs of a suitable fiber, for example glass (E, S, and D glass) or high temperature polymer fibers (e.g., KODEL polyester from Eastman Kodak) or polyphenylene sulfide fiber from Phillips Petroleum. Such thermally stable fiber reinforcement provides the composite with the desired structural rigidity, and/or a means of controlling shrinkage upon cure within the plane of the laminate. The use of the fibrous web can also yield a dielectric substrate with relatively high mechanical strength.

Examples of suitable fibrous webs are set forth in Table 1:

TABLE 1

| Manufacturer | Style | Thickness (inches) |
|---|---|---|
| Fiber Glast | 519-A | 0.0015 |
| Hexcel-Schwebel | 1674 | 0.0045 |
| Hexcel-Schwebel | 1080 | 0.0025 |
| BGF | 106 | 0.0015 |
| BGF | 7628 | 0.0069 |

The fibrous web can be present in an amount of 10 to about 60 vol. % of the dielectric substrate (i.e., the combined volume of the resin system, fibrous web, and any particulate filler), with about 10 to 40 vol. % preferred, and about 10 to about 25 vol. % of the total dielectric substrate especially preferred.

Suitable methods for preparing circuit materials comprising the above-described dielectric substrates is generally described in U.S. Pat. No. 6,048,807 (for systems cured at high temperature with or without a curing agent), and in U.S. Pat. No. 5,571,609 (for systems cured at low temperature with a curing agent).

Accordingly, the polymeric components, and, when used, other components such as curing agent, additive(s) and particulate filler are intimately mixed in a solvent until dissolved or dispersed into a uniform slurry. The particulate filler can be pretreated with coupling agents (preferably silanes) in a separate step for more efficient use of the agents. The mixture can then be formed into a film or sheet by methods known in the art, for example extrusion or casting. Alternatively, the mixture is combined with a fibrous web, for example by co-extrusion, lamination, or powder coating followed by heating to a temperature under pressure to allow the resin system to flow into the interfiber spaces of the glass cloth. In one embodiment, the fibrous web is saturated with a solution or slurry to the desired thickness, and then solvent is removed to form a prepreg. A stack up is made of one or more layers of prepreg with at least one layer of a conductive metal.

Useful conductive metals include stainless steel, copper, aluminum, zinc, iron, transition metals, and alloys comprising at least one of the foregoing, with copper preferred. There are no particular limitations regarding the thickness of the conductive metal layer, nor are there any limitations as to the shape, size or texture of the surface of the conductive layer. Preferably however, the conductive layer comprises a thickness of about 3 micrometers to about 200 micrometers, with about 9 micrometers to about 180 micrometers especially preferred. When two or more conductive metal layers are present, the thickness of the two layers can be the same or different.

Copper conductive layers are preferred. The copper conductive layer can be treated to increase surface area, treated with a stabilizer to prevent oxidation of the conductive layer (i.e., stainproofing), or treated to form a thermal barrier. Both low and high roughness copper conductive layers treated with zinc or zinc alloy thermal barriers are particularly useful, and can further optionally comprise a stain-proofing layer. Such copper conductive layers are available from, for examples, Oak-Mitsui under the tradename “TOB,” Circuit Foil Luxembourg under the tradename “TWS,” and Gould Electronics under the tradename “JTCS.” Other suitable copper conductive layers are available from Circuit Foil Luxembourg under the trade name “HFI”; from Co-Tech Copper Foil Company under the trade name “TAX”; and from Chang Chun Petrochemical Company under the trade name “PINK.”

The stack up is then densified and cured via lamination or a combination of lamination and oven baking. For example, the stack is placed in a press, which may or may not be evacuated to form a vacuum. The temperature is typically increased at a rate of about 2 to about 10° C./minute. Pressure can be applied at any time in the lamination cycle, for example about 2 to about 3 MegaPascal (MPa). The stack is held at the desired temperature and pressure for a time sufficient to adhere the layers, about 5 to about 45 minutes. The resulting article is then cooled while maintaining the desired pressure. The article can be removed from the press when the temperature is about 100° C. or lower, and stored until used. The lamination cycle is dependent on whether cure is effected by the thermal cure alone, or by free-radical curatives, or combinations of the two cure mechanisms. In a free radical cure, the stack is cured typically at about 330 to about 475° F. (165 to 245° C.). When the thermal cure is used, temperatures of about 575 to about 617° F. (300 to 325° C.) can be used.

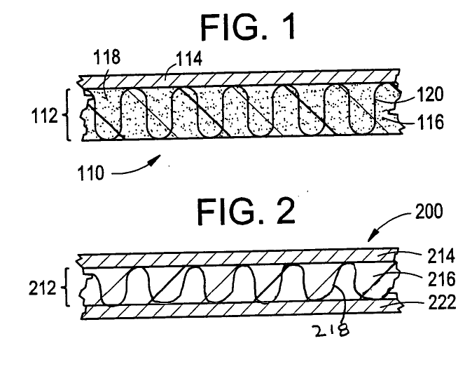

An exemplary circuit material comprising the inventive resin system is shown in FIG. 1, wherein a conductive layer 114 is disposed on a dielectric substrate 112 to form a circuit material 110. As used herein and throughout the disclosure, “disposed” means that the layers partially or wholly cover each other. The dielectric substrate 112 comprises the resin system 118 as described above, a particulate filler 116, and a woven fibrous web 120. Alternatively, the woven fibrous web 120 can be substituted with a non-woven fibrous assemblage (not shown). An adhesive can be disposed between dielectric substrate 112 and conductive layer 114 (not shown).

A second exemplary embodiment is shown in FIG. 2, wherein a double clad circuit material 200 comprises a dielectric substrate 212 disposed between two conductive layers 214, 222. Dielectric substrate 212 comprises the inventive resin system 216 and a woven fibrous web 218. Alternatively, the woven web 218 can be substituted with a non-woven assemblage (not shown). One or both conductive layers 214, 222 can be in the form of a circuit (not shown) to form a double clad circuit. An adhesive (not shown) can be used one or both sides of substrate 212 to increase adhesion between the substrate and the conductive layer(s). Additional layers can be added to result in a multilayer circuit.

The dielectric substrates described above have excellent processability, in particular low tack. In an advantageous feature, the compositions also have good electrical properties. In one embodiment, the substrates have a dissipation factor of less than about 0.003, specifically about 0.0019 to about 0.0025, measured as described below. In another embodiment, the substrates have a dielectric constant of about 2.8 to about 3.0, measured as described below. The copper bond strength is also good, in the range of about 3 to about 7 pli, specifically about 4 to about 6 pli, measured as described below.

The above-described materials and methods are further exemplified by the following examples, which are meant to be illustrative, not limiting.

### EXAMPLES

The tack is the adhesion of a material to itself. The tack of the prepreg material was measured as follows:
1. A 1-inch by 12-inch strip of prepreg was cut.
2. A 3-inch by 12-inch prepreg was cut.
3. The 1-inch prepreg strip was placed centrally onto the 3-inch strip, and the two were sandwiched between two pieces of release paper.
4. A 10-pound roller was rolled over the release paper and prepreg package for 30 seconds.
5. The release paper was removed, and a TMI (Model 80-90-01-009) was used to measure the force necessary to peel apart the 1-inch prepreg strip at 90 degrees from the 3-inch prepreg strip, at a rate of 12 inches/minute.
   The tack was measured a minimum of two times, and results averaged.

The etched laminate was measured for dielectric constant and dissipation factor in accordance with IPC-TM-650 2.5.5.5 and bond to copper in accordance with IPC-TM-650 2.48.

The resin components used to prepare the examples are shown in Table 2.

TABLE 2

| Trade Name | Source | Material |
|---|---|---|
| JSR 810 | Japan Synthetic | 1,2-syndiotactic polybutadiene |
| | Rubber | (Wt. average MW = 120,000) |
| B3000 | Nippon Soda, | 1,2-polybutadiene liquid resin |
| | Ltd. | (Wt. average MW = 3000) |
| Kraton | Shell | Diblock styrene-butadiene-copolymer |
| D1118X | | (30 wt % styrene; Wt. average |
| | | MW = 169,000) |
| Trilene 65 | Uniroyal | Ethylene propylene dicyclopentadiene |
| | | liquid rubber (MV = 7,000) |
| CE 44I | CE Minerals | 3 m²/g surface area ground amorphous |
| | | silica |
| TS 720 | Cabot Co. | 115 m²/g surface area fumed amorphous |
| | | silica |
| 1080 | BFG Industries | Glass fiber mat, 49 g/m² |
| 1674 | BFG Industries | Glass fiber mat, 97 g/m² |

### Examples 1-6

Examples 1-6 were formulated using the polymer system shown in Table 3, together with silane (where particulate filler was used), antioxidant, and flame retardant as described in U.S. Pat. No. 6,048,807. These components were dissolved and slurried in xylene, and coated onto 1080 glass in a laboratory dip coating operation to produce a prepreg having a thickness of about 0.005 inches. The prepreg was dried by allowing xylene to evaporate to dryness overnight at room temperature. Tack was measured as described above, and is also shown in Table 3.

TABLE 3

| | Ex. 1 | Ex. 2* | Ex. 3* | Ex. 4 | Ex. 5 | Ex. 6* |
|---|---|---|---|---|---|---|
| B3000 | 31.5 | 60.1 | 31.5 | 31.5 | 33.2 | 10.1 |
| Kraton D1118 | 28.5 | 28.5 | 57.0 | 0.0 | 0.0 | 11.2 |
| JSR 810 | 28.5 | 0.0 | 0.0 | 57.0 | 60.1 | 0.0 |
| Trilene 65 | 4.8 | 4.8 | 4.8 | 4.8 | 4.8 | 1.1 |
| TS 720 | 4.8 | 4.8 | 4.8 | 4.8 | 0.0 | |
| CE 44i | — | — | — | — | — | 76.5 |
| Tack (pli) | 0.012 | 2.5 | 0.28 | 0.0015 | 0.089 | ** |

*Comparative
** Too low to measure

The dried prepreg of Example 1 was low in tackiness, and easily handled. Tack was measured to be 0.012 pli.

Example 2, which is comparative, was formulated as in Example 1, except that syndiotactic 1,2-polybutadiene was removed and replaced by an equal amount of liquid 1,2-polybutadiene resin. Tack was found to be excessive. The prepreg could not be separated from itself without significant material transfer, which is an unacceptable condition for facile manufacturing of circuit material laminates. The measured tack was 2.5 pli, or 200 times that of Example 1.

In Example 3, which is comparative, syndiotactic 1,2 polybutadiene was replaced by another solid rubber, a diblock styrene-butadiene-copolymer (Kraton D 1118). Although the prepreg could be separated without material transfer, tack still would be too high for facile manufacture of product. The measured tack was 0.28 pli, or 23 times higher than Example 1. As certified by the manufacturers, the molecular weight of Kraton D 1118 is 169,000, and the molecular weight of JSR 810 is 120,000. This shows that mere replacement of liquid polybutadiene resin by another compatible high molecular weight elastomer does not produce the remarkable reduction of tack resulting from the use of the syndiotactic-1,2 polybutadiene.

Example 4 is the same as Example 1, except that the diblock styrene-butadiene-copolymer is completely replaced by an equivalent amount of syndiotactic 1,2-polybutadiene. Tack was slight, and the prepreg could be easily separated. Measured tack measured was 0.0015, or 8-fold less than example 1. This further demonstrates the effectiveness of the syndiotactic-1,2 polybutadiene in reducing tack, even when there is a considerable amount of liquid polybutadiene, and liquid EPDM, and only a small amount of fumed silica filler.

Example 5 is similar to Example 4, with similar ratios of polymeric species, but with no particulate filler. Measured tack was 0.089 pli, which is 8 times higher than Example 4, but prepreg could be separated without material transfer. This shows that the TS 720, which is a very high surface area filler, helps to reduce tack. There are limitations, however, in the use of TS 720 to reduce tack, because it imparts very high viscosity, has adverse effects on copper bond, and electrical dissipation factor; and is costly.

Example 6 was formulated similarly to present commercially available laminates, and contains a large amount of low surface area filler. The material was negligible in tack, and easily handled in manufacturing operations. The high filler loading, however, has the aforementioned drawbacks of higher dielectric constant and high drill wear.

### Examples 7-9

Example 7 was formulated as in Example 1, except that it was used to form a 0.010-inch thick prepreg on 1674 glass. The prepreg was laminated with 1-ounce TWS copper foil. Measurements of dielectric constant, dissipation factor and copper bond are shown in Table 4.

Example 8 was formulated with the same ratio of polymeric components as in Example 1. Ground amorphous silica was added to adjust the dielectric constant to a target level that is less than presently used commercially. This level of filler would be expected to result in excessive tack if the syndiotactic 1,2-polybutadiene was not present. In addition, a free radical curative (Perkadox 30, 2.7 wt. %) was included for more rapid cure. The material was made on production scale equipment on 1674 glass, at a thickness of 0.010 inches and using TWS copper. Properties are shown in Table 4.

Example 9 (Comparative) represents the same formulation as Comparative Example 6, in which a very high level of ground amorphous silica is used, but is made on production scale equipment at a thickness of 0.010 inches on 1674 glass. Typical property values are shown in Table 4.

TABLE 4

| | Example 7 | Example 8 | |
|---|---|---|---|
| | Laboratory Scale | Production Scale | Example 9* |
| B3000 | 31.5 | 19.4 | 10.1 |
| Kraton D1118 | 28.5 | 17.5 | 11.2 |
| JSR 810 | 28.5 | 17.5 | 0.0 |
| Trilene 65 | 4.8 | 2.9 | 1.1 |
| TS 720 | 4.8 | ] | ] |
| CE 44i | | 39.4 | 76.5 |
| Dielectric Constant | 2.817 | 2.970 | 3.312 |
| Dissipation Factor | 0.0024 | 0.00212 | 0.0032 |
| Copper Bond, 1 oz | 5.98 | 5.70 | 6.28 |
| copper (pli) | | | |

*Comparative

Examples 7 and 8, when compared to Comparative Example 9, illustrate that the critical properties of low dielectric constant and low dissipation factor can be obtained using low filler formulations, which are enabled by the remarkable effect of syndiotactic 1,2-polybutadiene on lowering tack of the prepregs. The lower dielectric constant follows directly from the fraction of silica filler. Lower dissipation factor was found in materials of this invention, Examples 7 and 8, compared to the previous state of the art material represented by Example 9; which is an added benefit in intended applications of these materials.

The singular forms “a,” “an,” and “the” include plural referents unless the context clearly dictates otherwise. The endpoints of all ranges reciting the same characteristic or component are independently combinable and inclusive of the recited endpoint. The recitation of “up to” a given amount is not inclusive of zero, i.e., at least some amount of the stated component is present. All references are incorporated herein by reference. Further, the terms “first,” “second,” and the like herein do not denote any order, quantity, or importance, but rather are used to distinguish one element from another.

While preferred embodiments have been shown and described, various modifications and substitutions may be made thereto without departing from the spirit and scope of the invention. Accordingly, it is to be understood that the present invention has been described by way of illustration and not limitations.

What is claimed is:

1. A circuit material, comprising
a conductive layer; and
a dielectric substrate disposed on the conductive layer, the dielectric substrate comprising, based on the total volume of the dielectric substrate composition,
about 10 to about 60 vol. % of a fibrous web; and
about 40 to about 90 vol. % of a cured composition formed from
a resin system comprising a syndiotactic polybutadiene elastomer in an amount of up to 100 vol. % of the total volume of resin system; and
0 to 40 vol. % of a particulate filler, based on the combined volume of the resin system and the particulate filler.

2. The circuit material of claim 1, wherein the resin system comprises about 5 to about 90 wt. % of the syndiotactic polybutadiene elastomer, and about 10 to about 95 wt. % of a liquid polybutadiene and/or polyisoprene resin, each based on the total weight of the resin system.

3. The circuit material of claim 1, comprising 0 to about 4 vol. % of the particulate filler, based on the combined volume of the resin system and particulate filler.

4. The circuit material of claim 1, wherein the resin system further comprises a low molecular weight ethylene propylene elastomer, wherein the low molecular weight ethylene propylene elastomer is present in an amount of up to about 20 wt. % of the total weight of the resin system.

5. The circuit material of claim 1, wherein the resin system further comprises a thermoplastic polymer capable of participating in cross-linking with the polybutadiene and/or polyisoprene resin, wherein the thermoplastic polymer capable of participating in cross-linking with the polybutadiene and/or polyisoprene resin is present in an amount of up to about 60 wt. % of the total resin system.

6. The circuit material of claim 5, wherein the thermoplastic polymer capable of participating in cross-linking with the thermosetting polybutadiene and/or polyisoprene resin comprises polybutadiene blocks and/or polyisoprene blocks, together with blocks derived from a monovinylaromatic compound.

7. The circuit material of claim 6, wherein the thermoplastic polymer capable of participating in cross-linking with the polybutadiene and/or polyisoprene resin is a diblock polybutadiene-styrene copolymer.

8. The circuit material of claim 1, wherein the resin system further comprises an effective amount of a free radical curing agent.

9. The circuit material of claim 1, wherein the conductive layer is copper.

10. A circuit comprising the circuit material of claim 1.

11. A method of making a circuit material, comprising
disposing onto a conductive layer a dielectric substrate prepreg, wherein the dielectric substrate prepreg comprises, based on the total volume of the dielectric substrate prepreg,
about 10 to about 60 vol. % of a fibrous web; and
about 40 to about 90 vol. % of a composition comprising
a resin system comprising a syndiotactic polybutadiene elastomer, in an amount of up to 100 vol. % of the volume of resin system; and
0 to 40 vol. % of a particulate filler, based on the combined volume of the particulate filler and the resin system; and
curing the resin system.

12. A circuit material, comprising
a conductive layer; and
a dielectric substrate disposed on the conductive layer, the dielectric substrate comprising, based on the total volume of the dielectric substrate composition,
about 10 to about 60 vol. % of a fibrous web; and
about 40 to about 90 vol. % of a cured composition, formed from
a resin system consisting essentially of about 5 to about 100 wt. % of a syndiotactic polybutadiene elastomer, based on the total weight of the resin system; and
up to about 40 vol. % of a particulate filler, based on the combined volume of the resin system and the particulate filler.

13. A circuit material, comprising
a conductive layer; and
a dielectric substrate disposed on the conductive layer, the dielectric substrate comprising, based on the total dielectric substrate composition,
about 10 to about 60 vol. % of a fibrous web; and
about 40 to about 90 vol. % of a cured composition, formed from
a resin system consisting of
about 5 to 100 wt. % of a syndiotactic polybutadiene elastomer,
0-95 wt. % of a thermosetting polybutadiene and/or polyisoprene,
0 to 50 wt. % of a polymer capable of crosslinking with the syndiotactic polybutadiene elastomer;
0-20 wt. % of an EPM or EPDM elastomer; and
an effective amount of a free radical initiator, each based on the total weight or volume of the resin system; and
up to about 40 vol. % of a particulate filler, based on the combined volume of the resin system and the particulate filler.
